(19) United States
(12) Patent Application Publication
(10) Pub. No.: US 2007/0159772 A1
(43) Pub. Date: Jul. 12, 2007

(54) IV pole attachable retractable cord power outlet

(76) Inventor: Sidney Morice, St. Paul Park, MN (US)

Correspondence Address: Curtis D. Kinghorn;Sirius Strategic, LLC, 6769 W. Shadow Lake Dr., Lino Lakes, MN, 55014, US

(21) Appl. No.: 11/398,923

(22) Filed: Apr. 6, 2006

Related U.S. Application Data
(60) Provisional application No. 60/758,026, filed on Jan. 11, 2006.

(51) Int. Cl. H02B 1/00

(52) U.S. Cl. 361/600

(57) ABSTRACT

The present invention is a power outlet device, attachable to an IV pole, that receives electrical power from a wall socket through an electrical cord and provides at least one electrical outlet with electrical power to be used to power devices used in hospital or clinical medical settings. The electrical cord becomes the sole cord necessary for providing electrical connectivity to the wall source. The power outlet device of the present invention is preferably provided in a compact housing that is easily mounted on the IV pole. On the face of the housing are preferably multiple electrical outlets that are used for each piece of portable electrical equipment that is mounted on the same IV pole. The power outlet is attachable to an IV pole through either hanging from a hook on the IV pole or by being clamped to the IV pole. The preferred embodiments of the invention have an electrical cord that is retractable into the housing of the device. The device preferably includes at least one circuit breaker in the electrical line. The power outlet of the present invention is preferably a re-usable piece of equipment that can be cleaned between patient uses according to a hospital's standard policy. Each IV pole has the potential of using several power outlets of the present invention (e.g. between 1-5) per pole, depending on the functionality of the IV pole. The invention also preferably includes a light source and a control switch to control the light source.

### REFERENCE TO CO-PENDING APPLICATION

This application claims the benefit of, and incorporates in by reference in its entirety, U.S. Provisional Application Ser. No. 60/758,026, filed Jan. 11, 2006.

### BACKGROUND OF THE INVENTION

1. Field of the Invention

The present invention is directed to devices and methods for providing electrical power to devices used in hospital or clinical medical settings and in particular to such devices and methods that are attached to an IV pole.

2. Description of Related Art

Poles for hanging bags of intravenous fluids (IV poles) are used in a wide array of therapeutic and diagnostic settings such as hospitals, nursing homes, out-patient clinics and home care to name but a few. In hospitals and clinical settings specifically, electrical technology is critical for patient care in delivering medications, IV fluids, nutrition, measuring oxygen saturation and respiratory effort, to name a few applications. Patients of all ages and with an extreme spectrum of illnesses and conditions, require numerous types of portable electrical equipment such as IV pumps during the course of their treatment. Often these IV poles support these electrical devices and other types of portable electrical equipment that have power cords that are typically plugged into wall sockets that provide electrical power.

Typically, all patients have intermittent needs for portability within the hospital (e.g. moving a patient from the surgical suite to a room or from the room to Radiology). Once patients that are on IVs are no longer bed-ridden, they are encouraged to be ambulatory and often need to take their IV poles with them as they move around their room, use the bathroom or walk down the hallways.

At present, when the patient is moved from one location to another, all electrical equipment that must move with the patient needs to be initially unplugged from the electrical source, the wall socket. The nurse, transporter or patient then has to determine what to do with several lengths of electrical cord while in transport. Typically, attempts are made to wrap the cords up into some type of loop and possibly secure them with a small strap onto the rolling IV pole. This requires several minutes of someone's time to prepare the equipment for transport, possibly taking time away from other patient care responsibilities and possibly delaying or prolonging the ultimate moving of the patient. Staff who care for these patients are often frustrated with the time and inefficiency of moving electrical equipment with or without patients and may be limited in their ability to reach behind or underneath beds to disconnect and ultimately reconnect each cord.

One of the issues that commonly occurs is for electrical cords to become tangled in transition or to fall from the strapping mechanism (if there is one) causing them to drop onto or in the way of the patient, nurse, transporter or other staff or visitors along the way creating a safety hazard for all. Additionally, when the cords become loosened, precious time is wasted while the transporter or nurse has to stop and resecure them to avoid any further delays.

Cords that are left dangling from the equipment, while the patient is being transported, can be stepped on, rolled over or caught spontaneously on any item in their path. The cord's prongs can be damaged as well and the casing for the cord can lose its integrity resulting in unsafe electrical conductivity and increased costs for replacement. Loose cords also represent a safety hazard when they are caught in a doorway or on another piece of equipment during transport creating a pull in the opposite direction or a rebound effect that may jeopardize the patient, the piece of equipment and other objects in its path.

Hospital safety reports show instances of children and compromised adults who have sustained serious injury when they have become entangled in loose or dangling electrical cords. Cases have been documented of children being electrocuted or even strangled from cords that were not secured properly.

These are clearly inefficient, time consuming, expensive, distracting, unsafe and dangerous conditions that stand in need of a solution. Especially in emergency situations, the need for a quick mechanism or system that can safely and securely manage the numerous electrical cords can be critically important.

In view of the foregoing, it can be seen that there is a need for a device that overcomes the problems and limitations set out above. In particular, there is a need for a device that manages extended lengths of electrical cords safely and securely when portability of the electrical devices is necessary and also when it is necessary to minimize the lengths of electrical cord presented when the IV poles with the electrical devices attached are in use in a single location.

### SUMMARY OF THE INVENTION

The present invention is a power outlet device that is attachable to an IV pole. The power outlet device receives electrical power from a wall socket through a single retractable electrical cord and provides at least one electrical outlet with electrical power to be used to power devices used in patient care such as hospital or clinical medical settings. The electrical cord becomes the sole cord necessary for providing electrical connectivity to the wall source.

The power outlet device of the present invention is preferably provided in a compact housing that is easily mounted on an IV pole. On the face of the housing are preferably multiple electrical outlets that are used for each piece of portable electrical equipment that is mounted on the same IV pole. The power outlet is attachable to an IV pole by either hanging from a hook on the IV pole or by being clamped to the IV pole. The preferred embodiments of the invention have an electrical cord that is retractable into the housing of the device. The device preferably includes a circuit protection device to electrically protect the electrical outlets from drawing excessive current. In the most preferred embodiment of the invention, this circuit protection device is at least one circuit breaker in the electrical line.

Because of the demands of the hospital or clinical environment that the power outlet within which the present invention will be used, it is desired that the power outlet device be made of rugged and durable hospital grade materials and built to hospital grade standards.

When there is a need to move the equipment attached to an IV pole, with or without a patient, the single cord of the present invention is removed from the wall outlet, given a short tug to activate the retractor mechanism and the cord is then reeled into the canister. This process takes literally seconds as opposed to several minutes to unplug and manage each loose end of cord as is currently done.

The power outlet of the present invention is preferably a re-usable piece of equipment that can be cleaned between patient uses according to a hospital's standard policy. Each IV pole has the potential of using several power outlets of the present invention (e.g. between 1-5) per pole depending on the functionality of the IV pole. The invention also preferably includes a light source and a control switch to control the light source.

There are many objects of the present invention in its various embodiments that may be addressed individually or in combinations and permutations. Each embodiment may address one or several of the following objectives.

An object of this invention in one embodiment or variant of the invention is to increase safety to patients and staff by minimizing the presence of loose electrical cords that may be tripped over or otherwise entangle or hinder the patients or staff.

Another object of the present invention in one embodiment or variant of the invention is to increase the portability of a source of electrical power.

Yet another object of the present invention in one embodiment or variant of the invention is to increase the efficiency of staff in supplying electrical power to devices used in hospital, clinical or home medical settings.

A further object of the present invention in one embodiment or variant of the invention is to increase the safety of equipment, particularly electrical equipment, during transport.

A further object of the present invention in one embodiment or variant of the invention is to provide a source of electrical power that is easy attachable to and fits existing portable IV transport poles.

Yet another object of the present invention in one embodiment or variant of the invention is to increase the ease of attachment and removal of a source of electrical power from an IV pole.

Yet another object of the present invention in one embodiment or variant of the invention is to provide a source of electrical power that is lightweight.

Yet another object of the present invention in one embodiment or variant of the invention is to provide a source of electrical power that is compact in size.

Yet another object of the present invention in one embodiment or variant of the invention is to provide a source of electrical power that is able to be cleaned within hospital specifications for multiple uses.

Yet another object of the present invention in one embodiment or variant of the invention is to provide a source of electrical power that is convenient in the context of a hospital, clinical or home medical setting.

Another object of the present invention in one embodiment or variant of the invention is to provide a source of electrical power that requires no training for its use.

These and other objects and advantages of the invention will be clear in view of the following description to the invention including the associated drawings.

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective view of one embodiment of the IV pole power outlet in use.

FIG. 2 is a front view of an embodiment of the IV pole power outlet of FIG. 1.

FIG. 3 is a back view of the IV pole power outlet of FIG. 1.

FIG. 4 is a top view of the IV pole power outlet of FIG. 1.

FIG. 5 is a side view of the IV pole power outlet of FIG. 1.

FIG. 6 is a front perspective view of an alternate embodiment of the IV pole power outlet of the present invention.

FIG. 7 is back perspective view of the embodiment of FIG. 6.

FIG. 8 is a sectional view of FIG. 1.

FIG. 9 is a front perspective view of another alternate embodiment of the IV pole power outlet of the present invention.

FIG. 10 is a front perspective view of another alternate embodiment of the IV pole power outlet of the present invention.

### DETAILED DESCRIPTION OF THE INVENTION

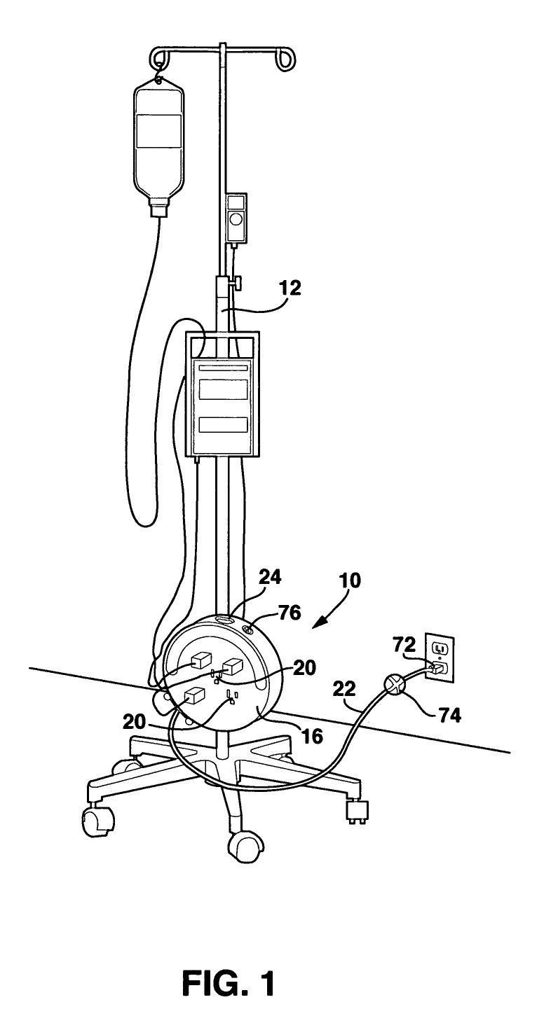

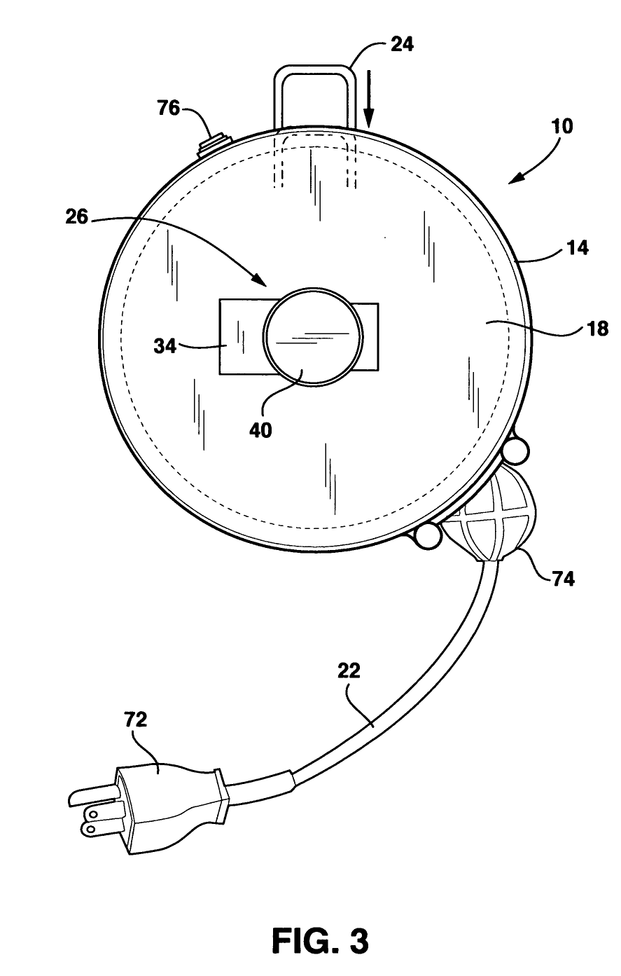

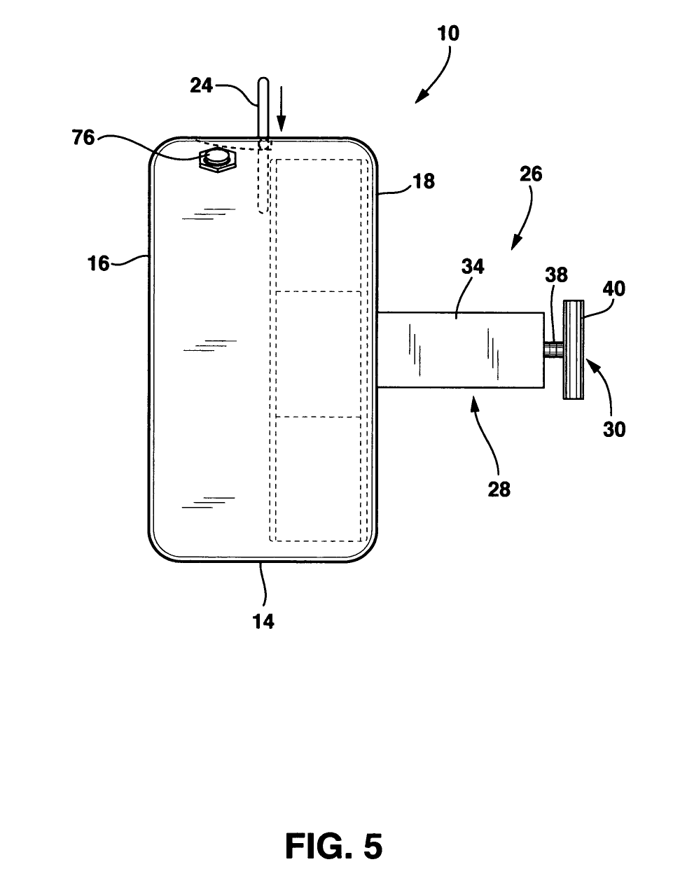

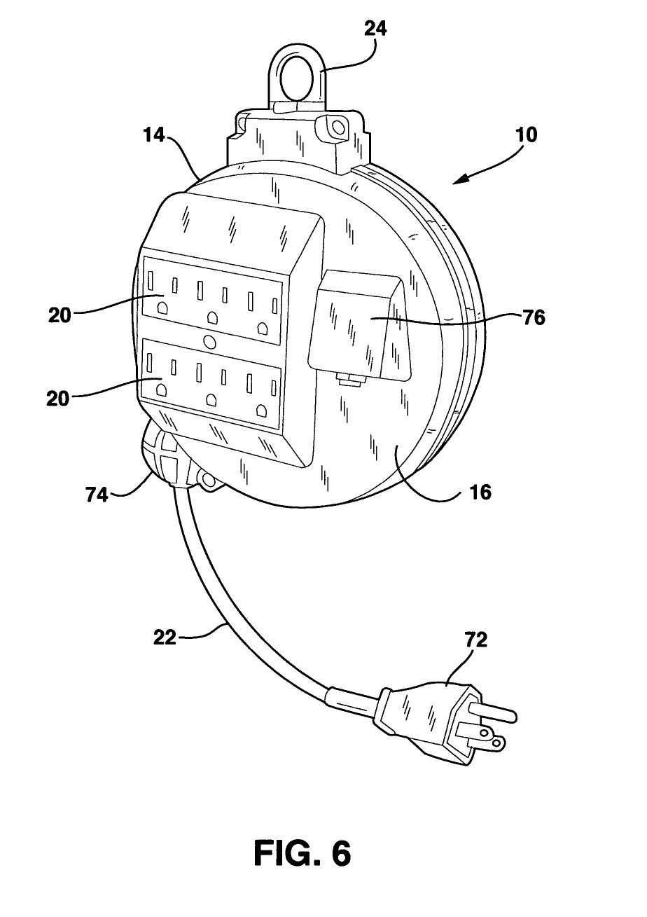

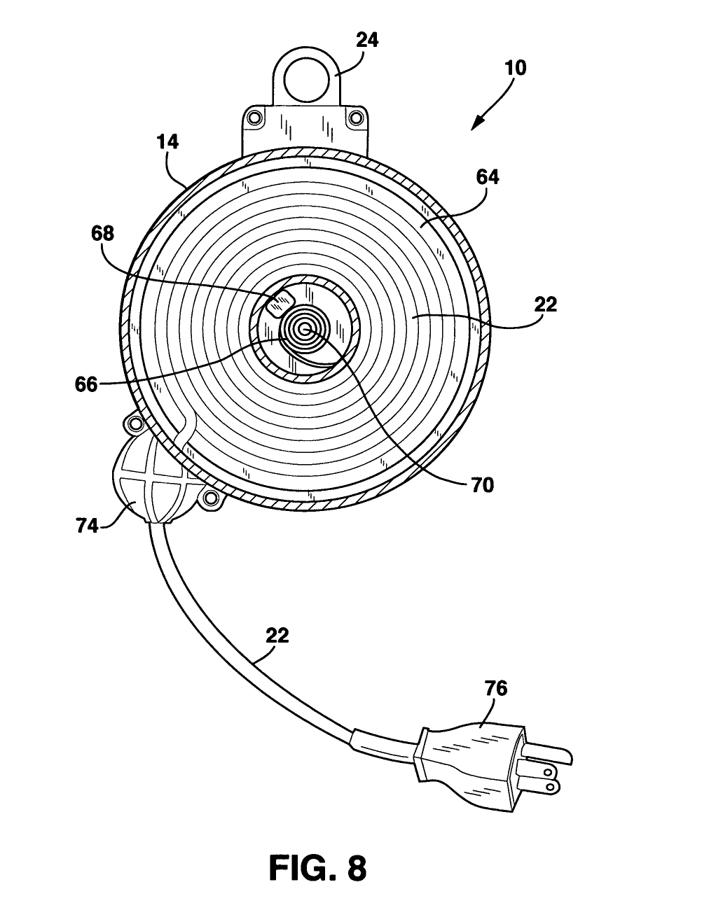

The IV pole retractable cord power outlet of the present invention is shown in FIGS. 1-10 generally labeled 10 and attached to an IV pole 12. The power outlet 10 has a housing 14 with a front face 16 and a back face 18, at least one electrical outlet 20 and an electrical cord 22.

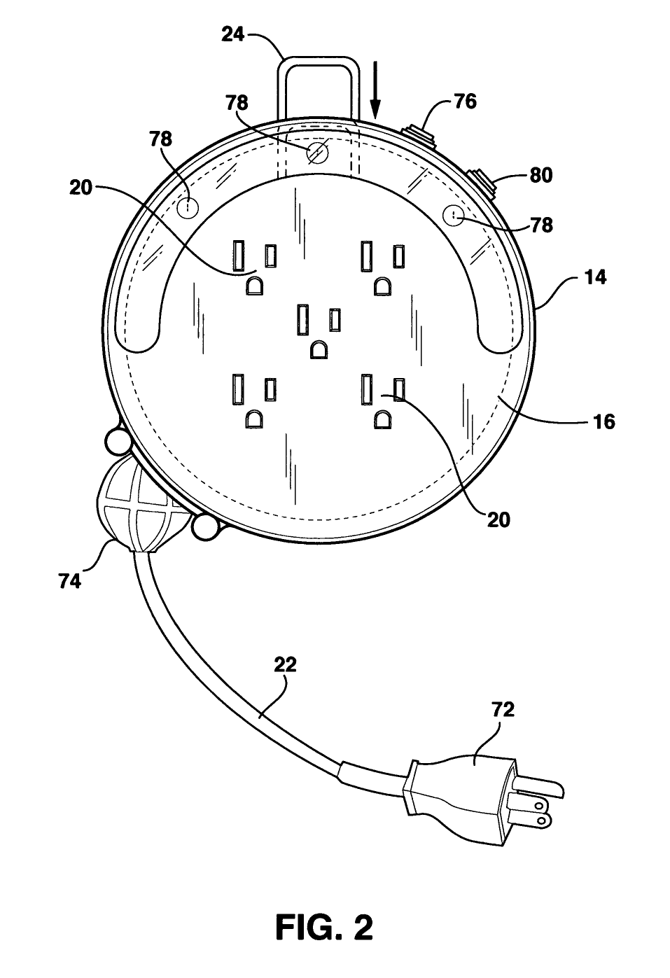

The power outlet 10 has a mechanism for attaching the housing to the IV pole 12. In the preferred embodiment shown in FIGS. 1-5, this attachment mechanism is hanger 24 at top of the housing 14 and a pole bracket 26 attached to its back face 18. The hanger 24 is a loop sized to receive a hook (not shown) such as those commonly attached to IV poles 12 for hanging items such as IV bags, fusion pumps, respiratory monitors, and feeding pumps. In a variant of this embodiment of hanger 24 shown in FIG. 2, the hanger 24 may move with respect to the housing 14, by means well understood in the art, from a retracted position (shown in phantom) to a fully extended position where hanger 24 may receive the hook of an IV pole 12.

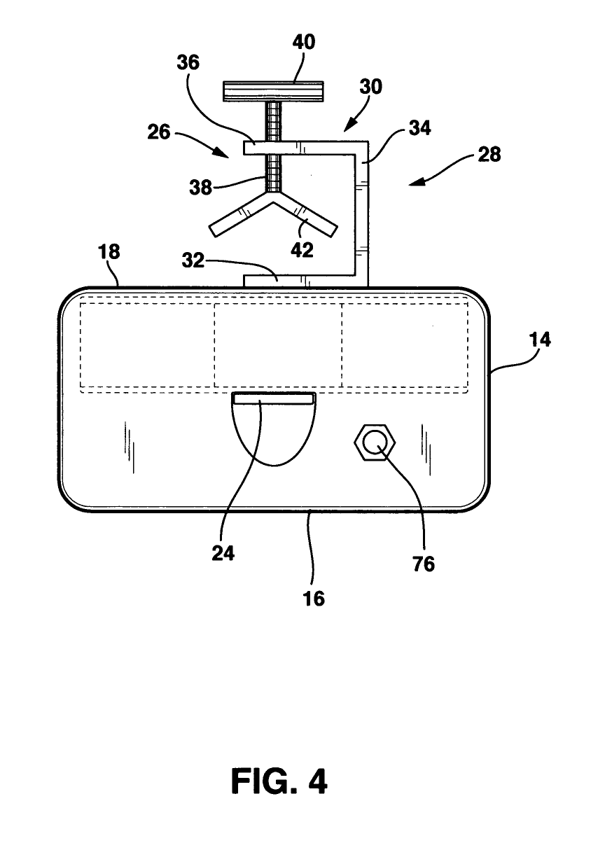

The pole bracket 26, best shown in FIG. 4, is a clamping device substantially in the form of a “C” clamp. In this embodiment of the pole bracket 26, pole bracket 26 has a base section 28 and a clamping mechanism 30. Base section 28 has a foot 32 that is attached to the back face 18. Foot 32 may be attached to back face 18 by any well understood means including screws, nuts and bolts, adhesives and being molded into the back face 18. An “L” shaped arm 34 extends from the foot 32 ending in a clamp arm 34 that is essentially parallel to and displaced from the foot 32. Clamp arm 34 has a threaded hole 36.

Clamping mechanism 30 has a threaded rod 38 with a knob 40 at one end and a pole engaging member 42 at the opposed end. Pole engaging member 42 is preferably shaped in a “V” shape or in a shape conformal to the IV pole 12. Threaded rod 38 is threaded through the threaded hole 36 of the clamp arm 34.

The spacing of the pole engaging member 42 from the foot 32 when the clamping mechanism 30 is in its most open position should be such as to allow the IV pole 12 to be moved easily between the pole engaging member 42 and the foot 32. Since a typical IV pole 12 has a diameter of about one inch, this spacing between the pole engaging member 42 and the foot 32 should be somewhat more than one inch.

In use, threaded rod 38 is rotated in the threaded hole 36 a sufficient amount to allow an IV pole 12 to be placed between the pole engaging member 42 and the foot 32. Threaded rod 38 is rotated by rotating the knob 40. After the IV pole 12 is placed between the pole engaging member 42 and the foot 32 the knob 40 is rotated so that the clamp engaging member 42 moves the W pole 12 into firm contact with the foot 32. Further rotation of the knob 40 secures the pole engaging member 42 into firm and locking contact with the IV pole 12. Because the pole engaging member 42 is shaped to engage IV pole 12 which has a substantially circular cross-section, pole engaging member 42 also allows the power outlet 10 to be attached to any device or structure, such as a bed or table, that has structure allowing the structure to fit between and be secured to the pole engaging member 42 and foot 32.

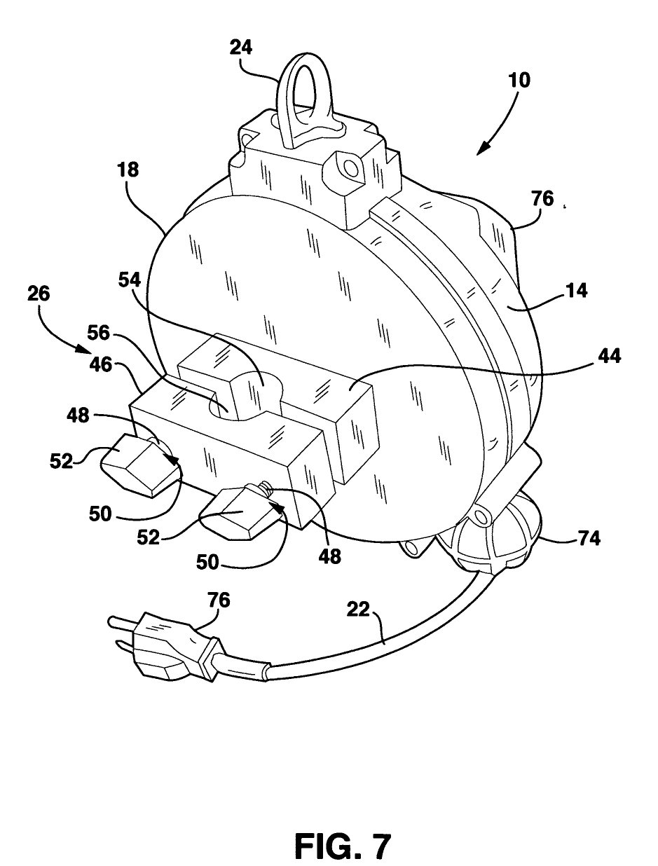

In an alternate embodiment of pole bracket 26, shown in FIG. 7, the pole bracket 26 has a base section 44, an opposed section 46 and a pair of threaded rods 48 each having a distal end 50. Each of the threaded rods 48 is threaded at least at its respective distal end 50 although the threaded rod 48 may be threaded along a substantial portion or all of its length. The pole bracket 26 also includes a pair of heads 52 each having a female threaded section that receives and conforms to the distal end 50 of the threaded rods 48 so that the heads 52 may be threaded onto the threaded rods 48. The threaded rods 48 extend from the base section 44 and pass entirely through the opposed section 46 so that the distal end 50 of the threaded rods 48 extend past the surface of the opposed section 46. The base section 44 and the opposed section 46 have a base cutout 54 and an opposed section cutout 56, respectively, sized to create a space slightly smaller than the diameter of the IV pole 12.

The spacing of the base section 44 and opposed section 46 when the pole bracket 26 is in its most open position should be such as to allow the IV pole 12 to be moved easily between the base section 44 and opposed section 46. Since a typical IV pole 12 has a diameter of about one inch, this spacing between the base section 44 and opposed section 46 should be somewhat more than one inch.

When it is desired to attach the IV pole power outlet 10 to the IV pole 12, at least one of the heads 52 is unthreaded from the distal end of a threaded rod 48 so that the IV pole 12 may be placed in the space formed by the base cutout 54 and opposed section cutout 56. Where only one head 52 is removed, it may be necessary to loosen the other head 52 to allow the IV pole 12 to be placed between the base section 44 and opposed section 46 in the space formed by the base cutout 54 and opposed section cutout 56. Alternately, both heads 52 may be removed from the distal ends 50 of the threaded rods 48. In either case, the opposed section 46 is moved away from the base section 44 and the IV pole 12 is placed in the space formed by the base cutout 54 and opposed section cutout 56. The opposed section 46 is brought close to the base section 44 so that the IV pole 12 is contacted by both the base section 44 and the opposed section 46. Both heads 52 are threaded onto the distal end 50 of the threaded rods 48 so that the heads 52 are brought into contact with the opposed section 46. As the heads 52 are tightened further, contact between the heads 52 and the opposed section 46 forces the opposed section 46 into squeezing and secure frictional contact with the IV pole 12. The heads 52 are tightened until the sufficient frictional force is produced to hold the IV pole power outlet 10 in place on the IV pole 12.

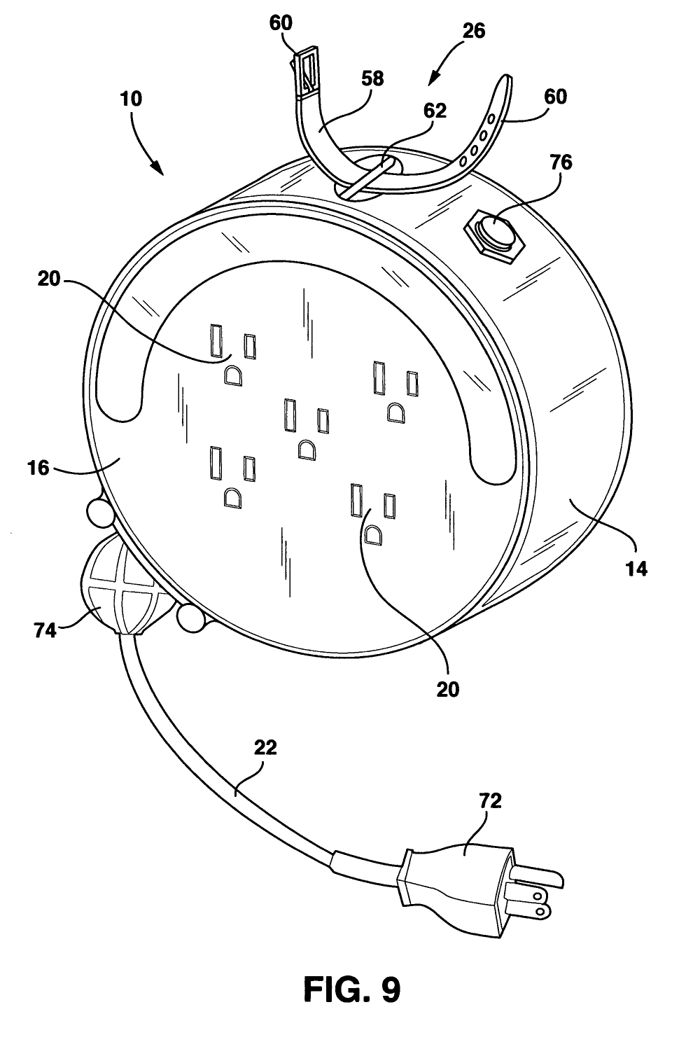

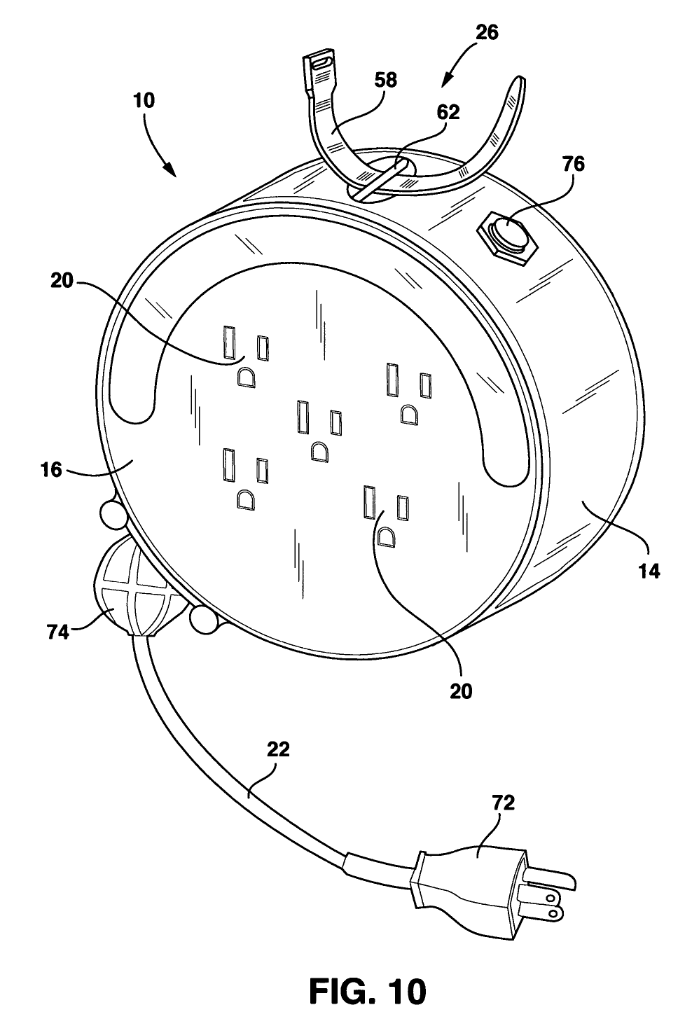

FIGS. 9-10 show other alternate embodiments of the power outlet 10 of the present invention. In these embodiments, the hanger 24 takes the form of a loop 58 attached to the top of the housing 14. The loop 58 may be a strap closable with a needle and eye fastener 60 (FIG. 9) such as is commonly used in clothing belts or could be a strap with a hook and loop fastener 61 (FIG. 10), such as is commonly sold under the trademark “VELCRO,” to close the loop. The loop forming hanger 24 may be attached to the housing 14 by any well known means including but not limited to passing through a retaining slot 62 molded in the top of the housing 14, screws, nuts and bolts or adhesives.

The housing 14 contains a cord reel 64, a rewind spring 66 and a retraction locking mechanism 68. Electrical cord 22 is wrapped around the cord reel 64 that turns about an axel 70 for managing the electrical cord 22. In the preferred embodiment, a rewind spring 66 attached to the cord reel 64 provides the retracting power to retract the cord 22 into the housing 14 by rotating the cord reel 64 around the axel 70. Alternately, the cord reel 64 may rotate to retract the electrical cord 22 by means of a hand crank or a motor which may also receive power from the electrical cord 22.

The retraction locking mechanism 68, as is well known in retracting mechanisms, locks the cord 22 in a desired degree of retraction around the cord reel 64 so that only the desired amount of cord 22 extends from the housing 14. Retracting locking mechanism 68 is disengaged by pulling cord 22 away from housing 14 and is re-engaged by ceasing the pulling of cord 22 away from housing 14.

The core reel 64, rewind spring 66 and retraction mechanism 68 is conventional and of the type known as an automatic reel since it is always biased to retract and wind the electrical power cord 22 which is connected thereto. Without limiting the mechanisms embodying the core reel 64, rewind spring 66 and retraction mechanism 68, examples of such mechanisms include, but are not limited to, those shown in the following US Patents whose teachings are incorporated herein in their entireties: U.S. Pat. No. 2,565,452 entitled “Reel” issued Aug. 21, 1951 to J. E. Johnson et al., U.S. Pat. No. 2,647,960 entitled “Weatherproof Reel for Electrical Cords or the Like” issued Aug. 4, 1953 to D. Benjamin, U.S. Pat. No. 3,450,369 entitled “Reel Construction having Pawl Optionally Mounted” issued Jun. 17, 1969 to C. H. Blanch et al. and U.S. Pat. No. 3,929,210 entitled “Retractable Cord Reel” issued Dec. 30, 1975 to M. Cutler et al.

Cord 22 has a plug 72 attached to one end and electrical outlets 20 functionally attached to the opposite end. Cord 22 has a cord stop 74 in advance of plug 72 and a circuit protection device, preferably a circuit breaker 76, connected to electrical outlets 20. Cord stop 74 attaches to the cord 22 near the plug 72 to prevent cord 22 from being retracted into the housing 14 far enough to bring plug 72 into contact with housing 14. Because of cord stop 74, plug 72, when cord 22 is fully retracted, is displaced a short distance from the housing 14 so that plug 72 can easily be located and grasped by the user of the power outlet 10.

Circuit breaker 76 preferably is a single circuit breaker protecting all the electrical outlets 20 but may also be a series of circuit breakers each protecting a specific electrical outlet 20. The circuit breaker 76 is preferably resettable, most preferably by pushing or toggling a button. However, the circuit protection device could also be a fuse including a single fuse protecting all the electrical outlets 20 or fuses for each of the electrical outlets 20.

The preferred embodiment of the power outlet 10 also includes at least one light source 78. The function of light source 78 is to provide illumination from the power outlet 10 in darkened conditions such as might exist in the environment of the power outlet 10 for example as a result of night time or due to being in polar regions during winter. This illumination illuminates the electrical cord 22 going into power outlet 10 and the cords plugged into the electrical outlets 20 to aid staff in plugging and unplugging cords into the electrical outlets 20. In addition, the light source 78 helps staff and others see the power outlet 10 and the IV pole 12 in darkened conditions to avoid tripping over or otherwise contacting the power outlet 10, IV pole 12 or items attached to or hanging from the IV Pole 12 including electrical cords, tubes or other associated items.

Light source 78 is preferably located on the front face 16 of housing 14 but could also be located elsewhere on housing 14. In the embodiment shown in FIG. 2, light source 78 consists of three LEDs. Although the embodiment shown in FIG. 2 has light source 78 consisting of three LEDs, light source 78 includes at least one light producing device and could include any number of such light producing devices including more or less light producing devices than three. Further, although the light producing source has been described as being an LED, other light producing sources well known in the art such as incandescent or fluorescent light, liquid crystal display (LCD) or plasma display to name but a few illustrative examples could be used.

A control switch 80 controls the light source 78. In the embodiment of FIG. 2, control switch is located on the top portion of housing 14 although it could be located elsewhere on housing 14. Control switch 80 controls the lighting produced by the light source 78. For example, as is well understood in the art, manipulating control switch 80 could produce multiple levels of illumination from light source 78 (e.g., off, low level, medium level or high level) or, where there are multiple light sources 78, successively activate a series of light sources 78 in response to manipulation of the control switch 80 to produce desired levels of illumination. In its simplest form, control switch 80 could simply be an on/off switch. Although the preferred embodiment of the power outlet 10 includes the light source 78 and control switch 80 described above, an embodiment of the power outlet 10 does not include these elements.

The power outlet 10 as described above preferably has a retractable cord 22 having a length sufficient to allow the power outlet 10 to be connected to a wall socket providing electrical power at useful lengths. For example, it is anticipated that a retractable cord 22 having a length of about twenty feet in length would be desirable but longer or shorter lengths could also be used.

Because of the demanding environment in which the power outlet 10 would typically be used, it is important that the components of the power outlet 10 be durable and strong. In this regard, with respect to the cord 22 and plug 72, it is preferred that the cord 22 and plug 72 set be listed to UL 498 or 817 or similar standard, identified with a green dot and be of a market hospital grade. The cord 22 is also preferably made to be hospital grade SJT163.

The blades of the plug 72 are preferably made of solid brass and are nickel plated. The cord 22 should preferably not move in the plug 72 more than about 0.03125 inch. The cord 22 and plug 72 should preferably be able to pass a strain relief test. In addition, the cord 22 and plug 72 should also preferably be durable enough to withstand an impact test and 500 pound crush test. Further, in the preferred embodiment, the plug 72 should preferably be clear for inspection purposes or made of a solid gray plastic. The housing 14 is preferably made of thermoplastic or metal although other materials that will occur to those skilled in the art can also be used.

The function of both the hanger 24 and the bracket 26 is to attach the IV pole power outlet 10 to the IV pole 12. Consequently, any means of attaching the IV pole power outlet 10 to an IV pole 12 that will occur to those skilled in the art are intended to fall within the scope of the invention. Further, although the preferred embodiment of the IV pole power outlet 10 includes both a hanger 24 and a bracket 26, the present invention could be practiced with only one of a hanger 24, bracket 26 or other means for securing the preferred embodiment of the IV pole power outlet 10 to the IV pole 12 as well as any possible combination or permutation of hanger 24, bracket 26 or other means for securing the preferred embodiment of the IV pole power outlet 10 to the IV pole 12.

In use, power outlet 10 is fixed to IV pole 12 by bracket 26 or by hanging the power outlet 10 by hanger 24 from a hook on the IV pole 12. Cord 22 is unwound from cord reel 64 as it turns about axel 70 to a desired length and plug 72 is inserted into a wall socket that supplies electrical power. This electrical power is provided to the electrical outlets through the plug 16. Hospital personnel are able to quickly and safely manage multiple plug-in electronic devices by inserting their respective plugs into an electrical outlet 20.

When it is desired to retract cord 22, as for example when it is desirable to move the IV pole 12, plug 72 is removed from the wall socket and cord 22 can efficiently be operated by manually pulling on the cord to rewind cord 22. The power outlet 10 is therefore available to be easily moved to a new location. This method of the present invention allows for ease of portability and movement of patients and equipment.

Besides being attached to an IV pole 12 as described herein, power outlet 10 can additionally be mounted to or suspended by hanger 24 or bracket 26 from any structure that allows such attachment or suspension. For example, power outlet 10 can be mounted to or suspended from hooks, bars or poles attached to walls, ceilings, floors, beds, chairs, tables or any other objects or structures having similar shape or function.

Although the preferred embodiment of the power outlet 10 has a retractable cord 22, a variant of the invention does not have a retractable cord 22. Instead, cord 22 has a single unvarying length and is not retractable into housing 14 or otherwise able to change its length. In addition, as mentioned above, while the preferred embodiment of the IV pole power outlet 10 includes both a hanger 24 and a bracket 26, a variant of the invention includes either a hanger 24 or a bracket 26 but not both. Further, although the preferred embodiment of the invention has at least one circuit breaker 76, a variant of the invention does not have a circuit breaker 76.

The invention described above is primarily intended and is useful for use in hospitals and clinics. However, the present invention is not required to be exclusive to hospitals and clinics. Laboratories, automotive repair facilities and any facility with mobile stands, carts and fixtures having poles or hooks can benefit by the use of this invention. In addition, the present invention may also find application in home use can to enhance the life of the residents by being implemented in all types of situations.

The present invention has been described in connection with certain embodiments, configurations and relative dimensions. However, description above is not to be construed as being absolutely particular. It is to be understood that the description given herein has been given for the purpose of explaining and illustrating the invention and are not intended to limit the scope of the invention. For example, additional methods of attaching the housing 14 to an IV pole 12, for retracting the cord 22 or for interrupting the power through the cord 22 when excessive current is drawn could be implemented in the present invention and still be within the scope of the invention. There are many materials and configurations that can be used in constructing the invention by those skilled in the art including all types of cables designed to carry current and information can be managed by this system. In addition, it is clear than an almost infinite number of minor variations to the form and function of the disclosed invention could be made and also still be within the scope of the invention. Consequently, it is not intended that the invention be limited to the specific embodiments and variants of the invention disclosed. It is to be further understood that changes and modifications to the descriptions given herein will occur to those skilled in the art. Therefore, the scope of the invention should be limited only by the scope of the claims.

I claim:

1. An IV pole retractable cord power outlet comprising:
a housing with a front face, a back face;
an IV pole attachment mechanism;
at least one electrical outlet attached to the housing;
an electrical cord having a first end and a second end, the electrical cord having a plug attached to the first end and the electrical outlets functionally attached to the second end, the electrical cord having a length sufficient to allow the power outlet to be connected to a wall socket providing electrical power at useful lengths.

2. The IV pole retractable cord power outlet of claim 1 wherein the IV pole attachment mechanism is a hanger, the hanger being a loop sized to receive a hook such as those commonly attached to IV poles.

3. The IV pole retractable cord power outlet of claim 2 wherein the hanger is movable with respect to the housing from a retracted position to a fully extended position where hanger may receive the hook of an IV pole.

4. The IV pole retractable cord power outlet of claim 2 wherein the hanger takes the form of a loop attached to the top of the housing.

5. The IV pole retractable cord power outlet of claim 4 wherein the hanger is a strap closable with a needle and eye fastener.

6. The IV pole retractable cord power outlet of claim 4 wherein the hanger is a hook and loop fastener to close the loop.

7. The IV pole retractable cord power outlet of claim 1 wherein the IV pole attachment mechanism is a pole bracket attached to the back face of the housing.

8. The IV pole retractable cord power outlet of claim 7 wherein the pole bracket is a clamping device substantially in the form of a “C” clamp.

9. The IV pole retractable cord power outlet of claim 8 wherein the pole bracket has:
a base section with a foot that is attached to the back face;
an “L” shaped arm that extends from the foot ending in a clamp arm that is essentially parallel to and displaced from the foot wherein the clamp arm has a threaded hole and wherein the spacing of the pole engaging member from the foot when the clamping mechanism is in its most open position should be such as to allow the IV pole to be moved easily between the pole engaging member and the foot; and
a clamping mechanism with a threaded rod with a knob at one end and a pole engaging member at the opposed end wherein the pole engaging member is preferably shaped in a “V” shape or in a shape conformal to the IV pole and wherein the threaded rod is threaded through the threaded hole of the clamp arm.

10. The IV pole retractable cord power outlet of claim 8 wherein the pole bracket has:
a base section having a base cutout;
an opposed section having an opposed section cutout wherein the base cutout and the opposed section cutout are sized when the base section and the opposed section are brought into contact with each other to create a space slightly smaller than the diameter of the IV pole;
a pair of threaded rods each having a distal end, each of the threaded rods being threaded at least at its respective distal end;
a pair of heads each having a female threaded section that receives and conforms to the distal end of the threaded rods so that the heads may be threaded onto the threaded rods;
wherein the threaded rods extend from the base section and pass entirely through the opposed section so that the distal end of the threaded rods extend past the surface of the opposed section.

11. The IV pole retractable cord power outlet of claim 1 wherein the housing contains a cord reel that turns about an axel, a rewind spring attached to the cord reel and a retraction locking mechanism and wherein the electrical cord is wrapped around the cord reel that turns about axel for managing the electrical cord whereby the rewind spring provides the retracting power to retract the cord into the housing by rotating the cord reel about the axel and whereby the retraction locking mechanism locks the cord in a desired degree of retraction around the cord reel so that only the desired amount of cord extends from the housing.

12. The IV pole retractable cord power outlet of claim 1 wherein the electrical cord has a cord stop attached to the cord near the plug to prevent cord from being retracted into the housing far enough to bring plug into contact with housing whereby the plug, when cord is fully retracted, is displaced a short distance from the housing so that plug can easily be located and grasped by the user of the power outlet.

13. The IV pole retractable cord power outlet of claim 1 further comprising a circuit protection device connected to the electrical outlets to electrically protect the electrical outlets from drawing excessive current.

14. The IV pole retractable cord power outlet of claim 13 wherein the circuit protection device comprises a circuit breaker.

15. The IV pole retractable cord power outlet of claim 14 wherein the circuit breaker is a single circuit breaker protecting all the electrical outlets.

16. The IV pole retractable cord power outlet of claim 14 wherein the circuit breaker is a series of circuit breakers each protecting a specific electrical outlet.

17. The IV pole retractable cord power outlet of claim 14 wherein the circuit breaker is resettable.

18. The IV pole retractable cord power outlet of claim 13 wherein the circuit protection device comprises a fuse.

19. The IV pole retractable cord power outlet of claim 1 further comprising a light source providing illumination and a control switch, electrically connected to the light source, that controls the illumination provided by the light source.

20. An IV pole retractable cord power outlet comprising:
a housing with a front face, a back face;
an IV pole attachment mechanism chosen from the group consisting of a hanger and a pole bracket;
at least one electrical outlet attached to the housing;
an electrical cord having a first end and a second end, the electrical cord having a plug attached to the first end and the electrical outlets functionally attached to the second end, the electrical cord having a length sufficient to allow the power outlet to be connected to a wall socket providing electrical power at useful lengths, wherein the electrical cord has a cord stop attached to the cord near the plug to prevent cord from being retracted into the housing far enough to bring plug into contact with housing whereby the plug, when cord is fully retracted, is displaced a short distance from the housing so that plug can easily be located and grasped by the user of the power outlet;
a cord reel that turns about an axel, a rewind spring attached to the cord reel and a retraction locking mechanism and wherein the electrical cord is wrapped around the cord reel that turns about axel for managing the electrical cord wherein the cord reel, axel, rewind spring and locking mechanism are contained within the housing and whereby the rewind spring provides the retracting power to retract the cord into the housing by rotating the cord reel about the axel and whereby the retraction locking mechanism locks the cord in a desired degree of retraction around the cord reel so that only the desired amount of cord extends from the housing;
a circuit protection device connected to the electrical outlets to electrically protect the electrical outlets from drawing excessive current wherein the circuit protection device is chosen from the group consisting of circuit breakers and fuses;
a light source providing illumination; and
a control switch, electrically connected to the light source, that controls the illumination provided by the light source.

21. A method of providing electrical power to devices used in hospital or clinical medical settings and in particular to such devices and methods that are attached to an IV pole comprising the steps of:
providing IV pole retractable cord power outlet comprising:
a housing with a front face, a back face;
an IV pole attachment mechanism;
at least one electrical outlet attached to the housing;
an electrical cord having a first end and a second end, the electrical cord having a plug attached to the first end and the electrical outlets functionally attached to the second end, the electrical cord having a length sufficient to allow the power outlet to be connected to a wall socket providing electrical power at useful lengths;
attaching the housing to an IV pole;
plugging plug into a wall socket that supplies electrical power.

22. The method of providing electrical power to devices used in hospital or clinical medical settings and in particular to such devices and methods that are attached to an IV pole of claim 21 wherein the step of providing IV pole retractable cord power outlet further comprises the step of:
providing, within the housing, a cord reel that turns about an axel, a rewind spring attached to the cord reel and a retraction locking mechanism and wherein the electrical cord is wrapped around the cord reel that turns about axel for managing the electrical cord wherein the cord reel, axel, rewind spring and locking mechanism are contained within the housing and whereby the rewind spring provides the retracting power to retract the cord into the housing by rotating the cord reel about the axel and whereby the retraction locking mechanism locks the cord in a desired degree of retraction around the cord reel so that only the desired amount of cord extends from the housing; and
wherein the method of providing electrical power to devices used in hospital or clinical medical settings and in particular to such devices and methods that are attached to an IV pole further comprises the steps of:
unwinding the electrical cord from cord reel to a desired length; and
engaging the locking mechanism to prevent the electrical cord from retracting into the housing.
